(19) United States
(12) Patent Application Publication
(10) Pub. No.: US 2026/0131508 A1
(43) Pub. Date: May 14, 2026

(54) MOULDING MALE DEVICE

(71) Applicant: SACMI COOPERATIVA MECCANICI IMOLA SOCIETA' COOPERATIVA, IMOLA (BOLOGNA) (IT)

(72) Inventors: Piero Maretti, Imola (Bologna) (IT); Riccardo Piancastelli, Imola (Bologna) (IT)

(21) Appl. No.: 18/878,450

(22) PCT Filed: Jul. 14, 2023
(86) PCT No.: PCT/IB2023/057217

§ 371 Date: Dec. 23, 2024

(30) Foreign Application Priority Data
Jul. 18, 2022 (IT) 102022000015025

(51) Int. Cl. B29C 43/18; B29C 35/16; B29C 43/52; B29L 31/26

(52) U.S. Cl. CPC B29C 43/18; B29C 35/16; B29C 43/52; B29L 2031/26

(57) ABSTRACT

A moulding male device for forming a sealing material inside a shell and for obtaining a seal, wherein the male device extends along a longitudinal axis and includes an inner body, which has a front wall configured to press a central portion of an end wall of the shell; an outer body, externally surrounding the inner body, having a front surface configured to press the sealing material, applied at least on an outer portion of the end wall, and to form the seal; a ducting circuit, configured to allow a transit of a cooling fluid inside the male device. The ducting circuit includes an outer circuit at least partly made in the outer body, and wherein the outer body comprises an inner jacket, surrounding the inner body; an outer jacket, surrounding the inner jacket; the outer circuit being at least partly made between the inner jacket and the outer jacket.

This invention relates to a moulding male device, in particular a moulding male device configured to form a sealing material inside a shell and to obtain a seal.

Closing elements comprising a shell, having an end wall and a lateral wall which extends from a peripheral edge of the end wall, and a seal which is made inside the shell and is positioned, in particular, on the end wall are very widespread on the market. Such closing elements are configured to close a supply opening of containers of various types, for example bottles and jars, and they include for example crown caps and threaded caps, which are made of metal.

In order to make such closing elements forming units are known comprising a supporting device, a moulding male device which is positioned above the supporting device and a movement device, configured to move the supporting device by raising it towards the moulding male device, or to move the moulding male device, by lowering it towards the supporting device. The end wall of the shell, having the lateral wall directed upwards is placed resting on the supporting device and has a sealing material already previously applied in it in such a way that the moulding male device can compression mould the sealing material, thereby forming the seal in the shell itself and making the closing element.

In order to form an annular seal, the sealing material may be applied, for example, in a ring shape in an annular outer portion of the end wall of the shell.

For that purpose, the moulding male device comprises an inner body having a front wall configured to press a respective central portion of the end wall of the shell and an outer body, externally surrounding the inner body, comprising an annular front surface, configured to press the ring-shaped sealing material applied in the annular outer portion, so as to form the annular seal.

According to one variant, in order to form a seal which also has a thin central part, which extends on the entire central portion of the end wall, the front wall may also be configured to press the central portion and at the same time to also form the central part of the seal, if the sealing material is also applied in the central portion of the end wall. In this case the seal comprises both the central part, which is thin and circular, and the outer part, which is annular and thicker, surrounding the central part.

An example of such forming machines is described in patent U.S. Pat. No. 4,388,058. In prior art forming machines it is necessary to wait for the seal, and also the shell, to cool before being able to move the moulding male device away from the closing element just made. In fact, the seal just formed by moulding is very hot and must be cooled in order to be able to guarantee good quality of the seal itself, that is to say, the absence of imprecisions in the shape and in the dimensions of the seal, which could compromise the effectiveness of the sealing itself, when the closing element is placed closing the container. The cooling must be as even and fast as possible, and, to allow a reduction in the cycle time, that is to say, the total amount of time which elapses from the start of the seal forming process to its completion, and therefore to allow a consequent increase in production efficiency. This need for cooling is particularly felt if the seal is formed in metal shells, since the latter are pre-heated when they are positioned resting on the supporting device and therefore they themselves help to further heat the seal.

For that purpose, a known technique is to prepare inside the moulding male device a ducting circuit made in the inner body, so that a cooling fluid can flow in it to cool the walls which form the seal.

However, the presence of the ducting circuit necessitates the presence of a plurality of components, which are complex and which render the moulding male device very complex and expensive to make, as well as difficult to maintain.

Utility model DE 298 00 426 describes a cooling or heating core, for injection moulding plastic, glass, deep drawing and extrusion, in the plastics industry and for tools for die-casting and casting metals in the metals industry, usable in an outer core. The cooling or heating core has a passage which extends axially as far as an outfeed hole, for feeding a cooling or heating medium to a head of the core. An outer surface of the cooling or heating core is provided with continuous grooves and ribs, to guide the cooling or heating medium externally from the head of the core to a bottom of the core. Document JPH0243009A refers to a moulding die for high precision and high efficiency moulding of a plastic product, which comprises a temperature regulating fluid flow path.

The aim of this invention is to make available a moulding male device for forming a sealing material inside a shell and thereby making a seal which overcomes the above-mentioned disadvantages of the prior art.

Another aim of this invention is to make available a moulding male device which allows effective cooling of the seal formed in the shell, to guarantee high production efficiency for closing elements comprising the shell and the seal, also maintaining a high quality of the seals obtained.

Yet another aim of this invention is to make available a moulding male device which comprises an effective cooling circuit, but which is simple and inexpensive to make.

Accordingly the invention provides a male device of a mould for forming a sealing material inside a shell and for obtaining a seal, wherein the male device extends along a longitudinal axis and comprises an inner body, which has a front wall configured to press a central portion of an end wall of the shell; an outer body, externally surrounding the inner body, having a front surface configured to press the sealing material applied at least on an outer portion of the end wall and to form the seal; a ducting circuit, configured to allow a transit of a cooling fluid inside the male device; characterised in that the ducting circuit comprises an outer circuit at least partly made in the outer body, and wherein the outer body comprises an inner jacket, surrounding the inner body; an outer jacket, surrounding the inner jacket; the outer circuit being at least partly made between the inner jacket and the outer jacket.

Thanks to the ducting circuit, it is possible to effectively cool the surfaces of the male device which form a sealing material to obtain the seal and/or are in contact with the shell.

Thanks to the fact that the outer circuit is at least partly made in the outer body, having the front surface configured to form the seal, it is possible to effectively cool the seal itself during a moulding step and that allows a good quality seal to be obtained, as well as a reduced cycle time and, consequently high production efficiency.

Thanks to the fact that the outer circuit is partly made between an inner jacket and an outer jacket, that allows effective cooling both of the inner jacket and of the outer jacket, and therefore of every part configured to form the sealing material from which to obtain the good quality seal.

According to one embodiment, thanks to the presence of the inner jacket and of the outer jacket, which are made as distinct and separatable components, the outer body can easily be made.

This allows easy disassembly of the outer body, if it is necessary to clean from the outer circuit any residues caused by cooling fluid transit.

That makes the moulding male device disclosed particularly simple to make and to assemble/disassemble.

According to a different embodiment, thanks to the fact that the outer circuit comprises an outer infeed stretch and an outer outfeed stretch, which are distributed around a longitudinal axis of the male device, and at least one outer connecting stretch positioned between the outer infeed stretch and the outer outfeed stretch, wherein the inner jacket and/or the outer jacket respectively comprise at least one first hollow and/or one second hollow for delimiting the outer infeed stretch, the outer outfeed stretch, or the outer connecting stretch, it is possible to obtain the outer circuit with simple machining.

In fact, it is enough to make a hollow in the inner jacket and/or in the outer jacket, to define the outer infeed stretch, the outer outfeed stretch, or the outer connecting stretch of the outer circuit without the need for complex and precision machining. In fact, it is enough for only one of the outer jacket or the inner jacket to have the hollow, since even if the other is internally free of machining and is smooth, the outer infeed stretch, the outer outfeed stretch or the outer connecting stretch may in any case be defined.

Respective hollows opposite each other, in the inner jacket and in the outer jacket, may however be present for specific cooling purposes.

According to another embodiment, the outer body comprises an upper part defined by an inner upper part of the inner jacket and by an outer upper part of the outer jacket; a lower part defined by an inner lower part of the inner jacket and by an outer lower part of the outer jacket; and wherein the outer circuit comprises an upper outer section made in the upper part and a lower outer section made in the lower part, connected to each other, which have different shapes.

Thanks to this other embodiment it is possible to guarantee flexibility in the machining and at the same time effectiveness of the cooling, since the outer circuit is shaped differently in the upper part and in the lower part of the outer body and, therefore, a flow rate of the cooling fluid can be configured differently in the upper part and in the lower part.

According to a further embodiment, the inner body comprises a forming element which is provided with the front wall, and a cup-shaped element; wherein the cup-shaped element surrounds in a sealed fashion the forming element. The ducting circuit comprises an inner circuit at least partly made between the forming element and the cup-shaped element.

Thanks to the presence of the inner circuit, it is possible to also effectively cool the central portion of the shell, or the central part of the seal formed on the shell.

According to a yet another embodiment, the cup-shaped element has a lateral outer surface which comprises a plurality of vent elements distributed around the longitudinal axis to allow the venting of any air trapped in the male device during a moulding operation.

Thanks to the vent elements, it is possible to further increase the quality of the seal formed since they allow the avoidance of bubbles in the seal caused by air trapped during moulding.

The invention can be better understood and implemented with reference to the accompanying drawings, which illustrate several example, non-limiting embodiments of it, in which:

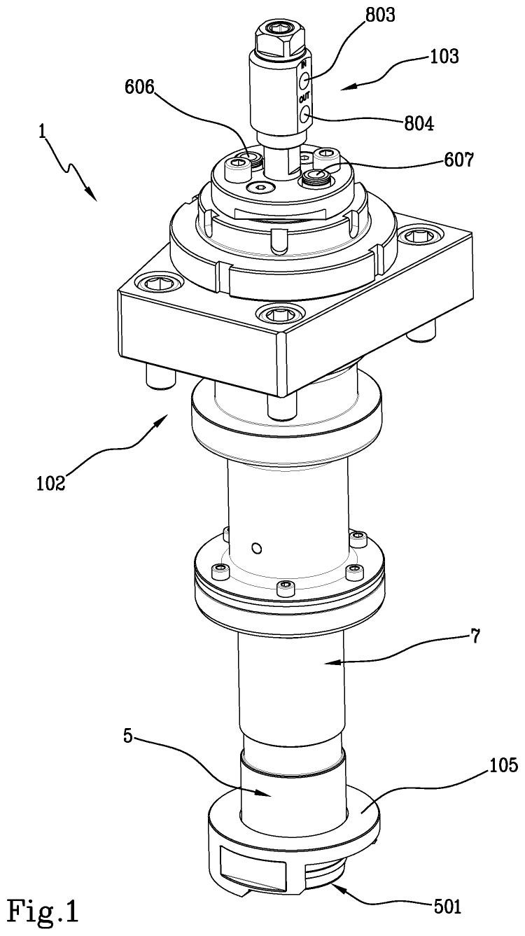

FIG. 1 is a perspective view of the moulding male device according to this invention, configured to form a sealing material inside a shell and to make a seal, comprising un ducting circuit to allow a transit of a cooling fluid inside the male device itself, in which the male device is in a forming step;

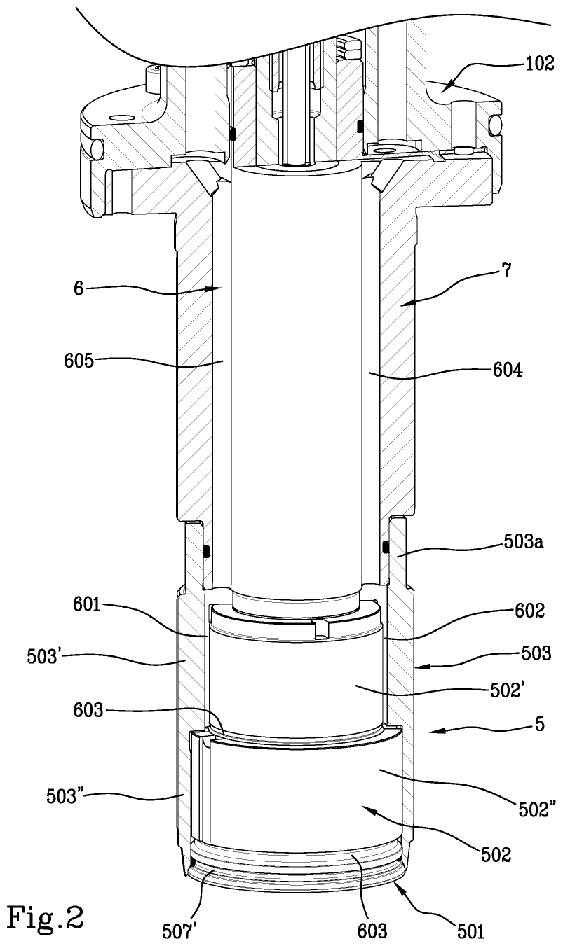

FIG. 2 is a perspective view partly in cross-section of the male device of FIG. 1, with some parts in cross-section and some part cut away for clarity, showing an intermediate infeed stretch and an intermediate outfeed stretch of an outer circuit made in an intermediate body, respectively connected to an outer infeed stretch and an outer outfeed stretch of the outer circuit made in an outer body, between which at least one outer connecting stretch is present, in which the outer body comprises an inner jacket and an outer jacket;

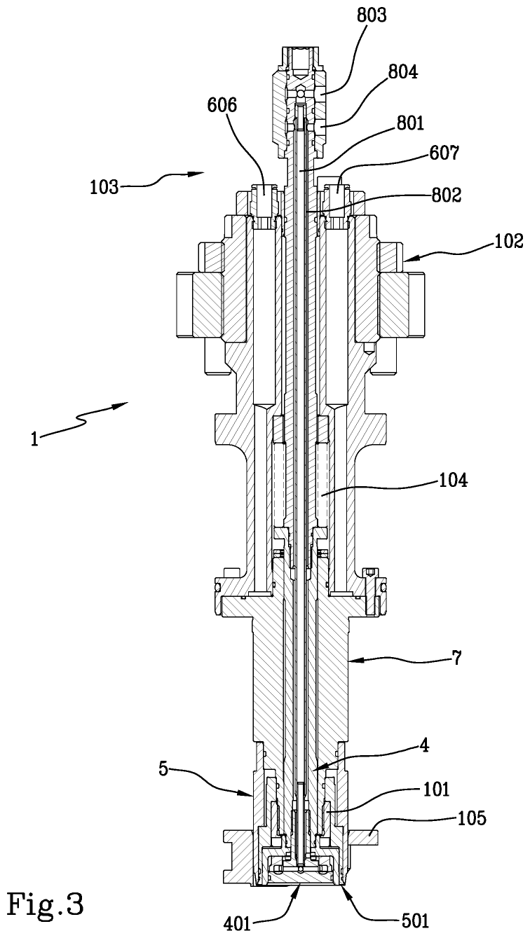

FIG. 3 is a cross-section, showing a plane passing through a longitudinal axis of the male device of FIG. 1;

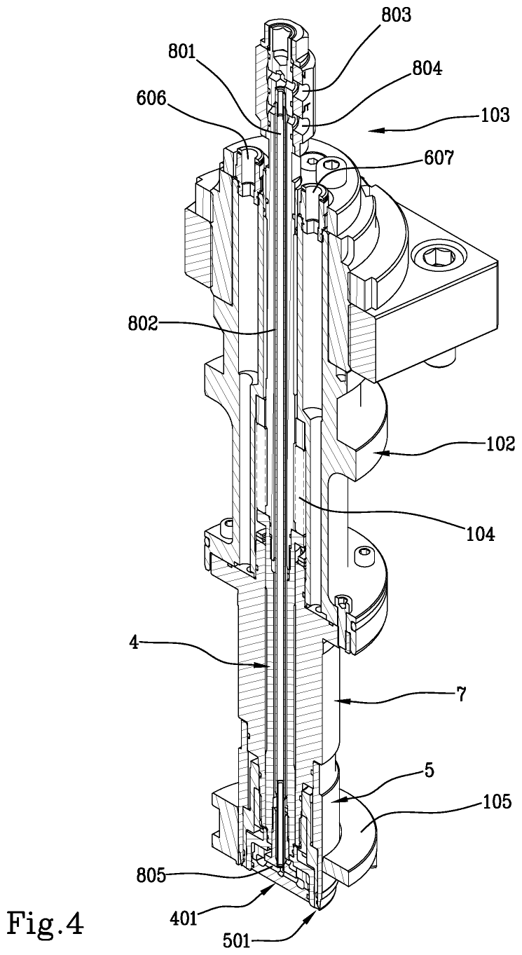

FIG. 4 is a perspective view in cross-section of the male device of FIG. 1;

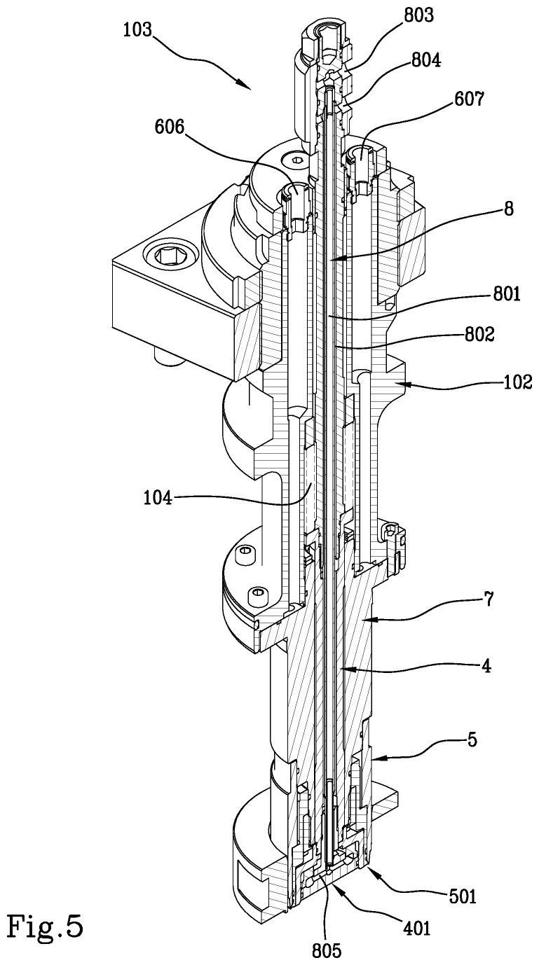

FIG. 5 is another perspective view in cross-section of the male device of FIG. 1;

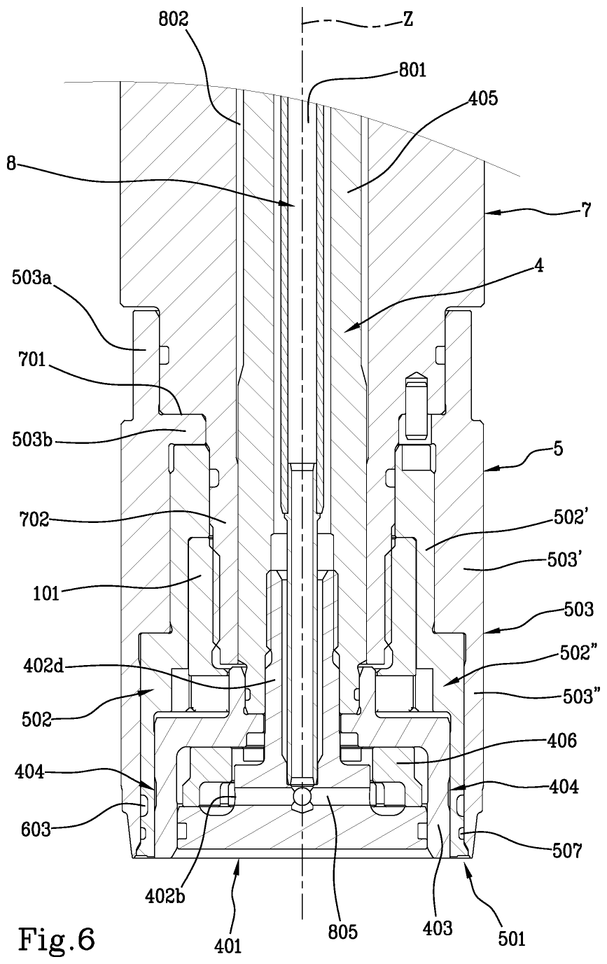

FIG. 6 is an enlarged and interrupted view of the cross-section of FIG. 3, showing a forming end of the male device of FIG. 1, with some parts cut away for clarity, showing the outer body, an inner body, positioned inside the outer body, and an intermediate portion of the intermediate body, positioned between the inner body and the outer body;

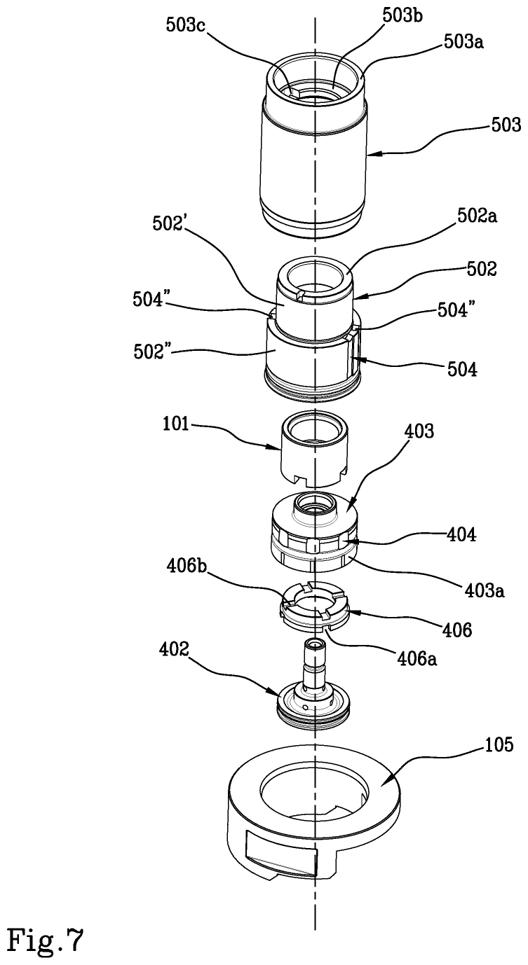

FIG. 7 is an exploded perspective view of the forming end of FIG. 6, showing the outer body, the inner body, a component for fixing the outer body to the intermediate body and an extractor, configured to extract the closing element from the moulding male device at the end of seal forming;

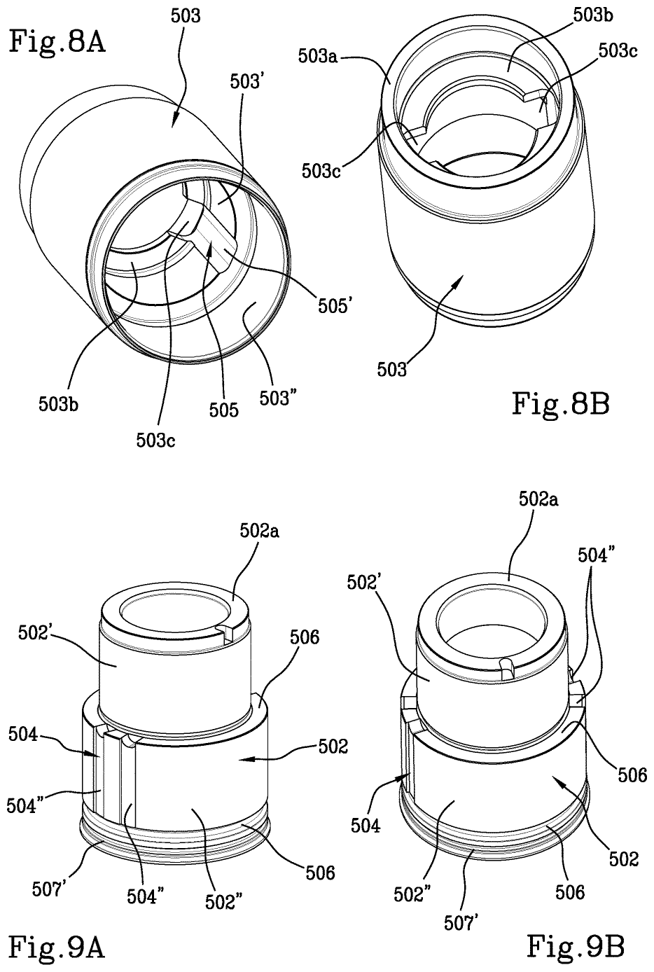

FIG. 8A is a perspective bottom view of the outer jacket of the outer body;

FIG. 8B is a perspective top view of the outer jacket of FIG. 8A;

FIG. 9A is a perspective bottom view of the inner jacket of the outer body;

FIG. 9B is a perspective top view of the inner jacket of FIG. 9A;

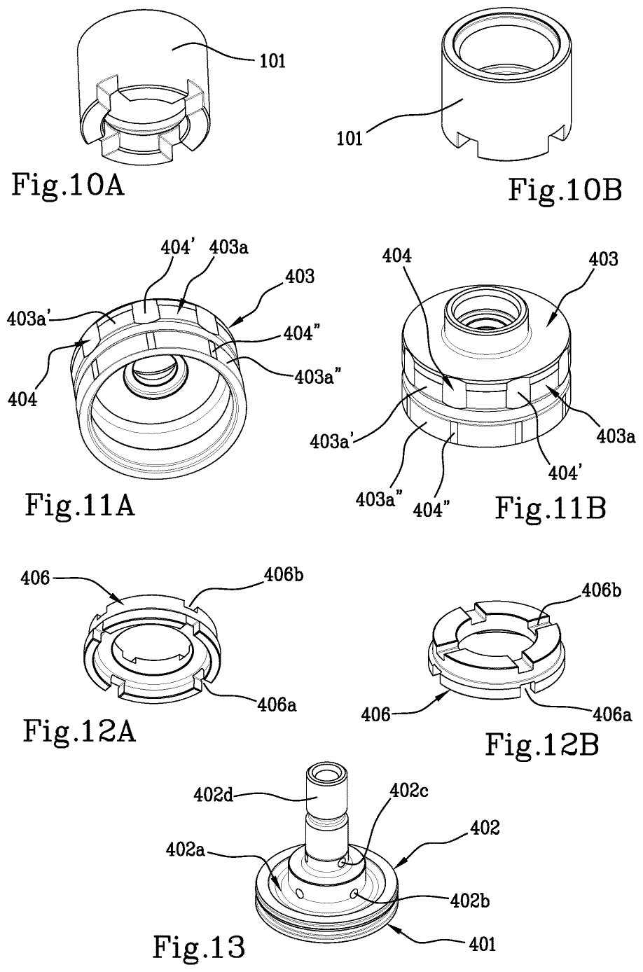

FIG. 10A is a perspective bottom view of the component for fixing the outer body to the intermediate body;

FIG. 10B is a perspective top view of the fixing component of FIG. 10A;

FIG. 11A is a perspective bottom view of a cup-shaped element of the inner body;

FIG. 11B is a perspective top view of the cup-shaped element of FIG. 11A;

FIG. 12A is a perspective bottom view of a ring of the inner body;

FIG. 12B is a perspective top view of the ring of FIG. 12A;

FIG. 13 is a perspective view of a forming element of the inner body;

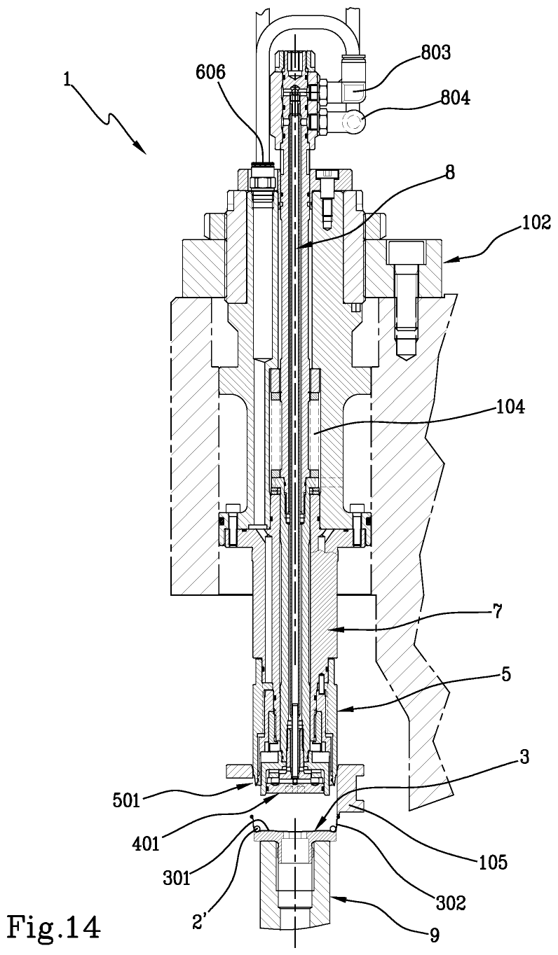

FIG. 14 is a cross-section of the male device placed above a supporting device in an inactive step, which precedes a forming step, in which the male device and the supporting device are in a respective rest configuration and are spaced apart from each other, and in which the shell is placed resting on the supporting device and has a sealing material applied in an outer portion of an end wall;

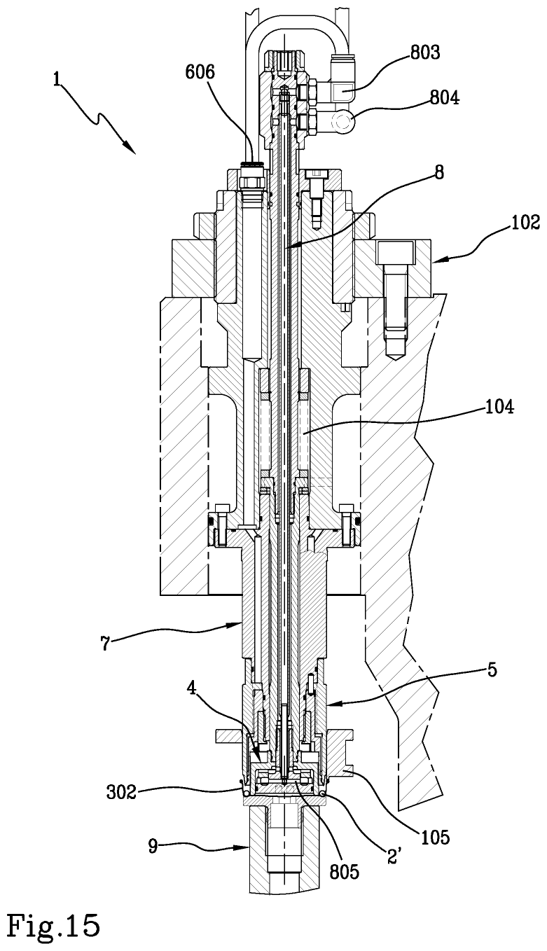

FIG. 15 is a cross-section of the male device and of the supporting device of FIG. 14 in an initial contact step, after the inactive step, in which the supporting device is in a first position, raised relative to the inactive step, in such a way that a front wall of the inner body presses a central portion of the end wall of the shell and a front surface of the outer body is spaced apart from the sealing material applied in the outer portion and is back relative to the front wall;

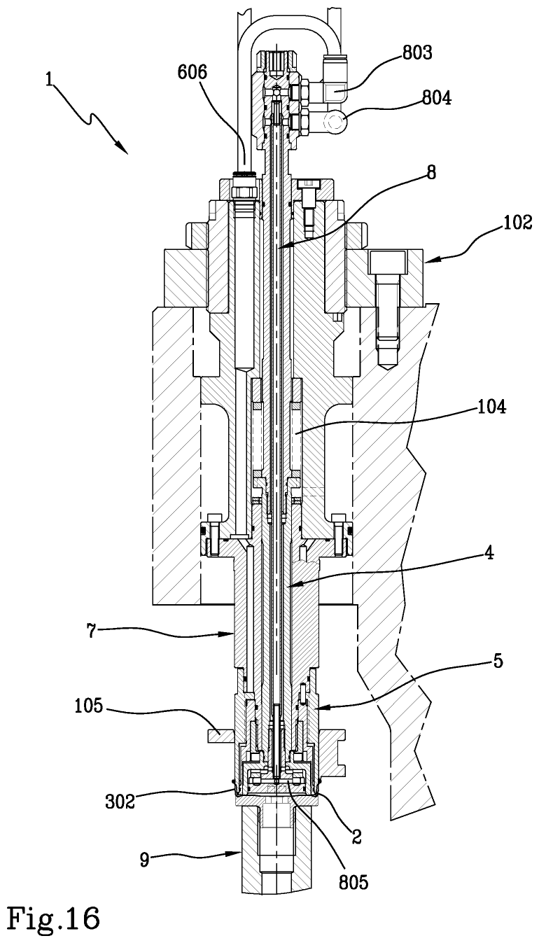

FIG. 16 is a cross-section of the male device and of the supporting device in the forming step, after the initial contact step, in which the supporting device is in a second position, further raised relative to the first position, in such a way that the front surface of the outer body presses and forms the sealing material, the inner body being back relative to the contact step so that said front surface is aligned with the front wall of the inner body;

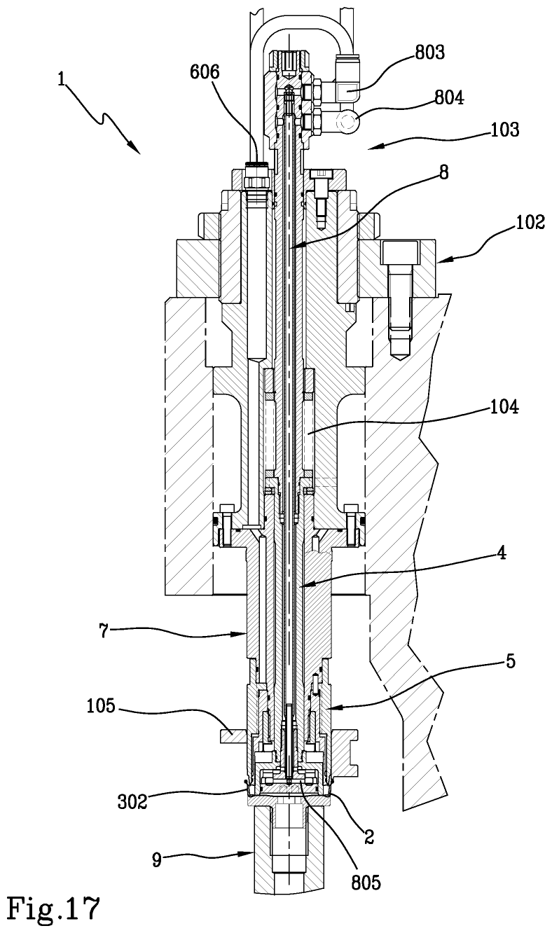

FIG. 17 is a cross-section of the male device and of the supporting device in a final contact step, after the forming step, in which the supporting device has returned to the first position in such a way that the front wall of the inner body continues to press the central portion of the end wall and the front surface of the outer body is spaced apart from the seal just formed and is back relative to the front wall;

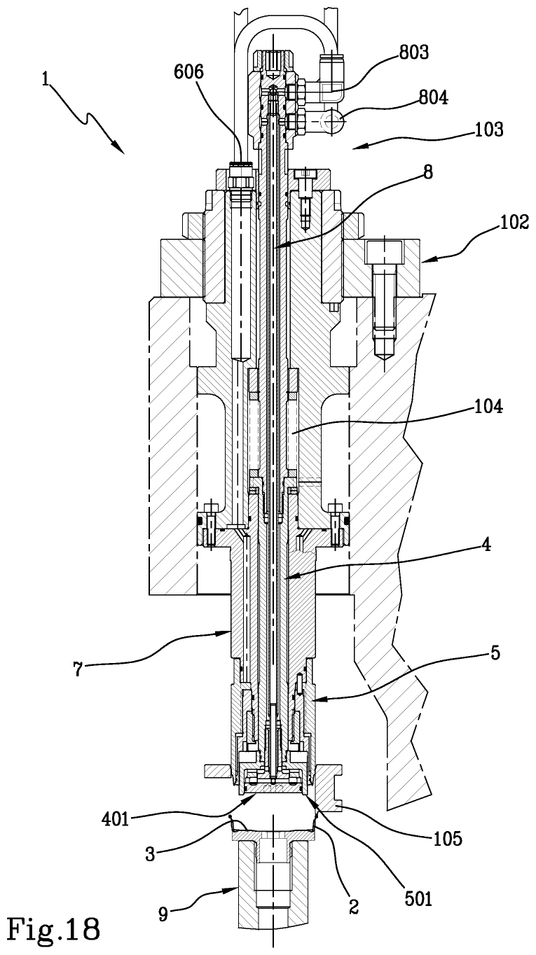

FIG. 18 is a cross-section of the male device and of the supporting device in another inactive step, after the final contact step, in which the male device and the supporting device are in the rest configuration and are spaced apart from each other, and in which the extractor of the male device has detached a closing element comprising the shell and the seal just formed from the male device itself;

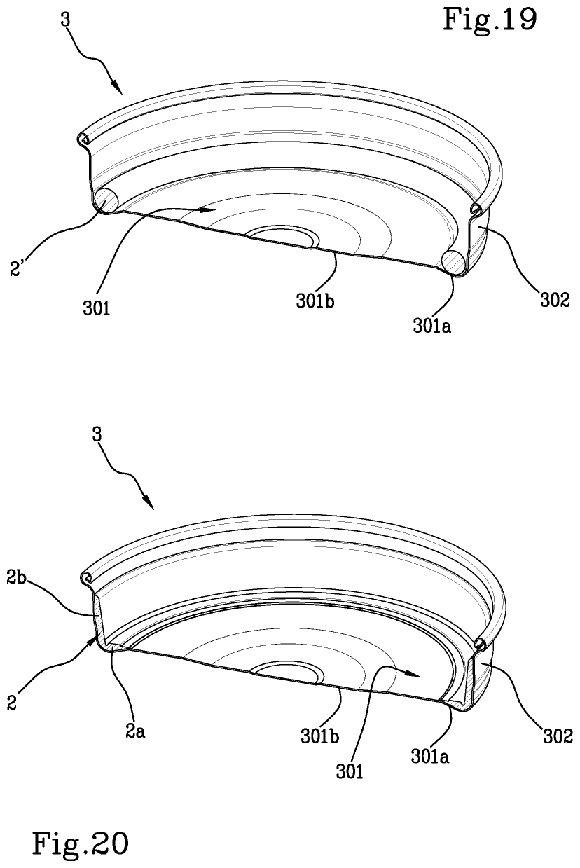

FIG. 19 is a perspective cross-section of the shell of FIG. 14, in which the sealing material is applied on the outer portion of the end wall of the shell;

FIG. 20 is a perspective cross-section of the closing element of FIG. 18, comprising the shell and the seal formed in it.

With reference to the appended Figures, the numeral 1 denotes a male device of a mould for forming a sealing material 2′ inside a shell 3, shown in FIGS. 14 to 20, and for making a seal 2.

Preferably, the shell 3 and the seal 2 formed in it make up a closing element, shown in FIGS. 18 and 20, which is configured to close a supply opening of various types of containers (not illustrated), for example bottles and jars. The shell 3 may, for example, be made of a metal material.

The sealing material 2′ is, for example, made of a polymeric material suitable for being compression moulded and is such that it guarantees a fluid seal when the closing element is applied to the respective container. The shell 3 comprises an end wall 301 and a lateral wall 302, which extends from a peripheral edge of the end wall 301.

The sealing material 2′ is applied at least on an outer portion 301a of the end wall 301 of the shell 3 to form the seal 2 and may have an annular shape, continuous or interrupted.

The end wall 301 also comprises a central portion 301b, surrounded by the outer portion 301a.

It should be noticed that the seal 2, once formed, may comprise an outer part 2a, for example annular, applied at the outer portion 301a, and also a lateral part 2b, at least partly applied in the lateral wall 302 of the shell 3, and more specifically in a zone of the lateral wall 302 adjacent to the peripheral edge, if the sealing material 2′ can flow outwards in the lateral wall 302 during the compression forming.

According to a variant not illustrated, the sealing material 2′ may be applied not just on the outer portion 301a of the end wall 301, but also at the central portion 301b. In this case, the seal 2, once formed, may also comprise a thin central part, which also extends on the central portion 301b of the end wall 301 of the shell 3.

The male device 1 extends along a longitudinal axis Z and comprises an inner body 4, which has a front wall 401 configured to press the central portion 301b of the end wall 301 of the shell 3.

It should be noticed that, in the embodiment shown in FIGS. 14 to 17 and 19, the sealing material 2′ is absent in the central portion 301b of the shell 3 and, therefore, the front wall 401 of the male device 1 is configured to directly make contact with and press the central portion 301b itself.

However, without limiting the scope of the invention, it shall be understood that, if the sealing material 2′ is also applied at the central portion 301b of the shell 3 to make the central part of the seal 2, the front wall 401 is suitable for pressing that central portion 301b of the end wall 301 also simultaneously forming the sealing material 2′ applied in it so as to obtain said central part.

The male device 1 additionally comprises an outer body 5, externally surrounding the inner body 4, which has a front surface 501 configured to press the sealing material 2′ applied at least on the outer portion 301a of the end wall 301 and to form the seal 2.

The male device 1 also comprises an extractor 105 which is configured to detach the closing element from the male device 1, at the end of seal 2 forming. The extractor 105 is ring-shaped and is positioned around the outer body 5.

However, it should be noticed that this is not necessary since the extractor 105 may not be joined to the male device 1 and be positioned in another part of closing element forming machinery.

The male device 1 additionally comprises a ducting circuit, configured to allow a transit of a cooling fluid, not illustrated, inside the male device 1 itself.

The ducting circuit comprises an outer circuit 6, shown in FIG. 2, which is at least partly made in the outer body 5.

It should be noticed that the ducting circuit allows effective cooling of the surfaces of the male device 1 in contact with the sealing material 2′ and/or in contact with the shell 3. In fact, thanks to the presence of the outer circuit 6, at least partly made in the outer body 5, the front surface 501 of the outer body 5 itself can be effectively cooled and, therefore, the latter being configured to form the sealing material 2′ positioned in the outer portion 301a of the end wall 301, it is possible to effectively cool the seal 2 itself during a compression forming step and to obtain a good quality seal 2 with a reduced cycle time and, consequently, high production efficiency.

The outer body 5 comprises an inner jacket 502, surrounding the inner body 4 and an outer jacket 503, surrounding the inner jacket 502.

In detail, the outer jacket 503 externally surrounds the inner jacket 502.

Advantageously, the outer circuit 6 is at least partly made between the inner jacket 502 and the outer jacket 503.

That allows effective cooling both of the outer jacket 503 and of the inner jacket 502 in a simple way, that is to say, effective cooling of every part configured to form the sealing material 2′ so as to obtain the good quality seal 2.

It should be noticed that the inner jacket 502 and the outer jacket 503 may be made as distinct and separatable components, so that they can easily be made and allow simple assembly or disassembly of the outer body 5.

Consequently it is possible to quickly clean the outer circuit 6. In fact, the cooling fluid may require periodic cleaning operations, which in this way are quick and easy to perform since it is possible to separate the inner jacket 502 from the outer jacket 503, and to separately clean the two different components 502, 503.

The inner jacket 502 and the outer jacket 503 are fixed to each other in a sealed fashion. In fact, there is a sealing element present, that is to say an annular seal 507, housable in a seat 507′, for example annular, made in the inner jacket 502 and positioned near the front surface 501.

The outer circuit 6 comprises an outer infeed stretch 602 and an outer outfeed stretch 601, which are distributed around the longitudinal axis Z, and at least one outer connecting stretch 603 positioned between the outer infeed stretch 602 and the outer outfeed stretch 601, wherein the inner jacket 502 and/or the outer jacket 503 respectively comprise at least one inner hollow 504 and/or one outer hollow 505 for delimiting the outer infeed stretch 602, the outer outfeed stretch 601, or the outer connecting stretch 603.

In detail, what is described above, that is to say, that the inner jacket 502 and/or the outer jacket 503 respectively comprise at least one inner hollow 504 and/or one outer hollow 505, means that the inner jacket 502 may comprise at least one inner hollow 504; or that the outer jacket 503 may comprise at least one outer hollow 505; or that both the inner jacket 502 and the outer jacket 503 may respectively comprise an inner hollow 504 and an outer hollow 505 for delimiting the outer infeed stretch 602, or the outer outfeed stretch 601, or the outer connecting stretch 603.

Thus, at least one jacket of either the inner jacket 502 or the outer jacket 503 comprises a respective hollow, the inner hollow 504 or the outer hollow 505.

Therefore, it is enough for at least one respective hollow to be present, in the inner jacket 502 and/or in the outer jacket 503, to be able to define the outer infeed stretch 602, or the outer outfeed stretch 601, or the outer connecting stretch 603 and this allows the possibility of making the outer body 5 without the need for complex and precision machining.

In fact, it should be noticed that, in FIGS. 8A-8B and 9A-9B the inner jacket 502 and the outer jacket 503 have respective hollows 504, 505 facing respective surfaces which are free of machining, but even in this way the respective stretch of the outer circuit 6 is in any case defined.

However, although not illustrated, it is also possible that an inner hollow 504 and an outer hollow 505 are respectively positioned in the inner jacket 502 and in the outer jacket 503, for example opposite each other, for delimiting the outer infeed stretch 602, or the outer outfeed stretch 601, or the outer connecting stretch 603.

The outer body 5 comprises an upper part, defined by an inner upper part 502′ of the inner jacket 502 and by an outer upper part 503′ of the outer jacket 503; and a lower part defined by an inner lower part 502″ of the inner jacket 502 and by an outer lower part 503″ of the outer jacket 503.

The outer circuit 6 comprises an upper outer section made in the upper part and a lower outer section made in the lower part, connected to each other, which have different shapes.

Thanks to the fact that the upper outer section and the lower outer section have different shapes, it is possible to make the outer body 5 in such a way as to guarantee flexibility in the machining and at the same time effective cooling. In fact, since the lower part of the outer body 5 extends as far as the front surface 501, which during forming is in contact with the sealing material 2′, it is possible to have a lower outer section with a flow rate which is greater, or more circumferentially distributed, than the upper section of the outer circuit 6. This allows the most efficient possible cooling of the front surface 501 itself.

For example, the upper outer section comprises an upper infeed section of the outer infeed stretch 602 and an upper outfeed section of the outer outfeed stretch 601 which comprise, respectively, a single outer upper hollow 505′ made in the outer upper part 503′ of the outer jacket 503.

In contrast, the lower outer section may comprise a lower outer infeed section of the outer infeed stretch 602 and a lower outer outfeed section of the outer outfeed stretch 601 which comprise, respectively, a pair of inner lower hollows 504″ made in the inner lower part 502″ of the inner jacket 502.

It should be noticed that the outer infeed stretch 602 and the outer outfeed stretch 601 are linear and parallel to the longitudinal axis Z. In particular, the upper outer section and the lower outer section of the outer infeed stretch 602 and of the outer outfeed stretch 601 are linear, and parallel to the longitudinal axis Z since each outer upper hollow 505′ and the inner lower hollows 504″ are all parallel to each other and parallel to the longitudinal axis Z.

In detail, the outer infeed stretch 602 and the outer outfeed stretch 601 are diametrically opposed, the outer upper hollows 505′ and, in pairs, and the inner lower hollows 504″ being diametrically opposed whilst the outer connecting stretch 603 comprises at least one curved portion defined by a respective curved hollow 506, made in the inner jacket 502, or in the outer jacket 503. In FIGS. 9A and 9B it can be seen how the curved hollow 506 is made in the inner jacket 502.

The curved hollow 506 is present near the front surface 501, immediately above the seat 507′ intended to receive the sealing element 507.

Another curved hollow 506 is made between the upper part and the lower part of the outer body 5.

It should be noticed that, both the inner jacket 502 and the outer jacket 503 may be made using SLM (acronym for Selective Laser Melting) technology, which is an additive manufacturing technique, that is to say, gradually depositing metal powder, which uses a laser source to melt that powder. The metal powder may, for example, be of the Steel Powder Metals type. Alternatively, according to a different embodiment, the inner jacket 502 and the outer jacket 503 may be made using SLM technology, but in a single body.

The male device 1 comprises an intermediate body 7 having an annular shoulder 701 which abuts an annular shelf 503b of the outer body 5, said annular shelf 503b being positioned axially on the opposite side to the front surface 501. The intermediate body 7 has an intermediate portion 702 which projects axially from the annular shoulder 701, to which the outer body 5 is fixed in a sealed fashion.

It should be noticed that the intermediate portion 702 is interposed between the outer body 5 and the inner body 4. In detail, the intermediate portion 702 is in contact both with the outer body 5 and with the inner body 4.

The front surface 501 is defined by respective front portions of the inner jacket 502 and of the outer jacket 503 which cooperate to shape the seal 2 during forming of the sealing material 2′, together with the front wall 401.

On the side axially opposite to the front surface 501, the outer jacket 503 has an upper edge 503a which projects relative to the annular shelf 503b, in such a way that the latter upwards can abut the annular shoulder 701 and downwards can receive an upper edge 502a of the inner jacket 502.

The annular shelf 503b comprises two openings 503c through which the cooling fluid is made to pass.

In fact, the outer circuit 6 comprises an intermediate infeed stretch 604 and an intermediate outfeed stretch 605, which are made in the intermediate body 7 and are connected respectively to the outer infeed stretch 602 and to the outer outfeed stretch 601, since they lead to the openings 503c.

Fixing of the outer body 5 to the intermediate body 7 is possible thanks to a fixing component 101, shown at least in FIGS. 10A and 10B, which is removably fixable by means of a thread to the intermediate portion 702 of the intermediate body 7 and allows the inner jacket 502 and the outer jacket 503 to be locked to each other and, once they have been assembled together as the outer body 5, allows them to be fixed to the intermediate portion 702.

The intermediate body 7 is in turn fixed to a supporting body 102 of the male device 1.

The inner body 4 comprises a forming element 402 which has the front wall 401. Moreover, the inner body 4 comprises a cup-shaped element 403 which surrounds in a sealed fashion the forming element 402.

The ducting circuit comprises an inner circuit 8 at least partly made between the forming element 402 and the cup-shaped element 403.

The cup-shaped element 403 externally surrounds the forming element 402. The cup-shaped element 403 comprises a lateral outer surface 403a which comprises a plurality of vent elements 404 distributed around the longitudinal axis Z to allow the venting of any air trapped in the male device 1 during forming of the sealing material 2′.

Thanks to the vent elements 404, the air trapped during forming can be made to come out and that can avoid bubbles forming in the seal 2 formed and therefore promote the making of high quality seals 2.

It can be seen how the lateral outer surface 403a comprises an upper portion 403a′ and a lower portion 403a″ and how the vent elements 404 comprise respectively upper vent grooves 404′ and lower vent grooves 404″ respectively positioned in the upper portion 403a′ and in the lower portion 403a″ of the lateral outer surface 403a.

The upper vent grooves 404′ are shaped and distributed differently from the lower vent grooves 404″. In fact, it can be seen how the upper vent grooves 404′ have a greater angular extent than the lower vent grooves 404″. Alternatively, or additionally, the upper vent grooves 404′ are angularly positioned in different positions relative to the lower vent grooves 404″.

Preferably, the vent elements 404, that is to say, the upper vent grooves 404′ and the lower vent grooves 404″, are positioned parallel to the longitudinal axis Z and are circumferentially regularly spaced.

The male device 1, and in particular the inner body 4, comprises an inner core 405, with tubular shape, to which the forming element 402 is coupled, and a ring 406 which is interposed between the cup-shaped element 403 and the forming element 402, surrounds the forming element 402 and is in contact with the front wall 401. The cup-shaped element 403 externally surrounds the forming element 402.

In detail, the ring 406 is in contact with an upper surface 402a of the front wall 401.

As already indicated, the inner circuit 8 is at least partly made between the forming element 402 and the cup-shaped element 403.

Moreover, the inner circuit 8 is at least partly made in the inner core 405 and around the ring 406. In fact, the inner circuit 8 comprises an inner infeed stretch 801 and an inner outfeed stretch 802 which are inside the inner core 405, and lead into the forming element 402.

It should be noticed that the inner infeed stretch 801 is centrally made in the inner core 405, which is hollow, whilst the inner outfeed stretch 802 surrounds the inner infeed stretch 801.

Moreover, the inner infeed stretch 801 and the inner outfeed stretch 802 are parallel to each other and parallel to the longitudinal axis Z.

The inner circuit 8 also comprises an inner connecting stretch 805 between the inner infeed stretch 801 and the inner outfeed stretch 802, which extends around the ring 406.

The inner connecting stretch 805 comprises a lower inner section positioned between the upper surface 402a of the front wall 401 and a lower surface of the ring 406, an upper inner section positioned between an upper surface of the ring 406 and a lower surface of the cup-shaped element 403 and a lateral inner section, positioned between a lateral outer surface of the ring 406 and a lateral inner surface of the cup-shaped element 403.

The forming element 402 comprises infeed openings 402b which are positioned near the upper surface 402a of the front wall 401, for connecting the inner infeed stretch 801 to the inner connecting stretch 805. The forming element 402 also comprises outfeed openings 402c, which are positioned spaced apart from the upper surface 402a of the front wall 401, and are placed at a distance from it greater than the axial height of the ring 406, for connecting the inner connecting stretch 805 to the inner outfeed stretch 802. In detail, the infeed openings 402b connect the inner infeed stretch 801 to the lower inner section of the inner connecting stretch 805, whilst the outfeed openings 402c connect the inner outfeed stretch 802 to the upper inner section of the inner connecting stretch 805.

The forming element 402 additionally comprises a tubular part 402d, for coupling to the inner core 405.

The ring 406 also comprises lower and upper connecting openings 406a, 406b positioned circumferentially around the ring 406, for connecting to each other respectively the lower inner section and the lateral inner section of the inner connecting stretch 805, the lateral inner section and the upper inner section of the inner connecting stretch 805.

In this way, the cooling fluid of the inner circuit 8 flows from the inner infeed stretch 801 through the infeed openings 402b to the inner connecting stretch 805, that is to say, to the lower inner section of the connecting stretch 805; from the lower inner section through the lower connecting openings 406a of the ring 406 to the lateral inner section; from the lateral section through the upper connecting openings 406b to the upper inner section; and finally from the latter, through the outfeed openings 402c, from the inner connecting stretch 805 to the inner outfeed stretch 802.

If we now consider the male device 1, it has a forming end defined by the front wall 401 of the forming element 402 and by the front surface 501 of the outer body 5, wherein the front surface 501 externally surrounds the front wall 401. The front surface 501 comprises respective front portions of the inner jacket 502 and of the outer jacket 503.

During the forming, the sealing material 2′ is in contact both with the front portions of the inner jacket 502 and of the outer jacket 503 and with a lateral zone of the cup-shaped element 403 which, being cooled, by the lateral inner section of the inner connecting stretch 805 helps to cool the seal 2.

The male device 1 also has a connecting end 103, which is positioned on the opposite side to the forming end defined by the front wall 401 and by the front surface 501.

The outer circuit 6 is connected to an outer infeed 607 and to an outer outfeed 606 which are made in the supporting body 102, to which the intermediate body 7 is fixed, and which are positioned in the connecting end 103 so that the cooling fluid of the ducting circuit enters from the outer infeed 607 and exits from the outer outfeed 606 through the outer circuit 6.

The inner circuit 8 is connected to an inner infeed 803 and to an inner outfeed 804 which are made in the inner body 4 in the connecting end 103. The outer circuit 6 and the inner circuit 8 can be connected in series, and therefore the outer outfeed 606, or the inner outfeed 804 can be connected respectively to the inner infeed 803, or to the outer infeed 607, to make the cooling fluid flow in sequence from/to the outer circuit 6 from/to the inner circuit 8.

In FIGS. 14 to 18 the outer circuit 6 and the inner circuit 8 are connected in series, and therefore the outer outfeed 606 is connected to the inner infeed 803.

Alternatively, according to a variant not illustrated, the outer circuit 6 and the inner circuit 8 may be connected in parallel and, therefore, the inner infeed 803 and the outer infeed 607 may be fed separately. That allows different flow rates for the inner circuit 8 and for the outer circuit 6 if the cooling requirements of the inner body 4 and of the outer body 5 are different.

As already indicated, the outer body 5, the intermediate body 7 and the supporting body 102 are fixed to each other in an integral way and are stationary.

In contrast, the inner body 4 is slidable relative to them. In fact, the male device 1 comprises elastic elements 104 interposed between the inner body 4 and the supporting body 102, which are configured to obtain a back/forward movement of the inner body 4 relative to the supporting body 102, and therefore also relative to the outer body 5, as described in detail below.

FIGS. 14 to 18 show a forming unit for obtaining the closing element comprising the shell 3 and the seal 2, shown in FIG. 20.

The forming unit comprises the male device 1 described above and a supporting device 9, on which the shell 3 is rested, which is placed below the male device 1.

The forming unit also comprises a movement device, not illustrated, configured to move the supporting device 9 by raising it towards the male device 1 in such a way as to form the sealing material 2′.

Below is a description of the fact that it is the supporting device 9 which is raised by the movement device. However, that is not necessary, since it could be the male device 1 which is lowered towards the supporting device 9, in order to form the seal 2.

In use, the male device 1 is placed above the supporting device 9 in an inactive step, which precedes forming of the sealing material 2′, as shown in FIG. 14.

Both the male device 1 and the supporting device 9 are in a respective rest configuration and are positioned away from each other. It should be noticed that the inner body 4 is projecting relative to the outer body 5 and that the front wall 401 is axially nearer the supporting device 9 than the front surface 501 is, since the elastic elements 104 are in an extended configuration.

The extractor 105 is also in a rest configuration in which it is projecting relative to the front wall 401.

The shell 3 is placed resting on the supporting device 9 and the sealing material 2′ is applied in an outer portion 301a of the end wall 301.

As shown in FIG. 15, in an initial contact step, the supporting device 9 is in a first position, raised relative to the inactive step and the central portion 301b of the end wall 301 of the shell 3 has reached a position of contact and pressure with the front wall 401. The front wall 401 retains the shell 3 in position on the supporting device 9.

The front surface 501 of the outer body 5 is still spaced apart from the sealing material 2′ applied in the outer portion 301a of the end wall 301 and is still axially back relative to the front wall 401. The elastic elements 104 are still in an extended configuration.

The cooling fluid of the inner circuit 8 can already cool the shell 3 by means of the front wall 401, which is cooled by the inner connecting stretch 805 of the inner circuit 8, in particular by the lower inner section of the inner connecting stretch 805.

It should be noticed that, during raising of the supporting device 9, an end edge of the lateral wall 302 of the shell 3 makes contact with the extractor 105 which is also raised, following the lateral wall 302.

As shown in FIG. 16, in a forming step, which follows the initial contact step, once the supporting device 9 continues to be raised and is brought into a second position, further raised relative to the first position, the gradual movement of the supporting device 9 is absorbed by the elastic elements 104, which deform and are compressed.

The inner body 4 follows the supporting device 9 and is also raised, sliding at least relative to the outer body 5.

The sealing material 2′ present in the outer portion 301a is formed by the front surface 501 of the outer body 5, and in more detail between the respective front portions of the inner jacket 502 and of the outer jacket 503 which cooperate to shape the outer part 2a of the seal 2. Also being crushed, the sealing material 2′ flows outwards until it defines the lateral part 2b of the seal 2, which is at least partly applied in the lateral wall 302 of the shell 3.

Since the inner body 4 is back due to the thrust of the supporting device 9, relative to the initial contact step, the front surface 501 is brought into a position in which it is aligned with the front wall 401.

It should be noticed that, during the forming step for forming the sealing material 2′, the elastic elements 104 apply a thrust action which guarantees correct holding of the position of contact between the front wall 401 and the end wall 301 of the shell 3.

The cooling fluid of the outer circuit 6 can already cool the sealing material 2′ by means of the front surface 501 whilst the shell 3 can continue to be cooled by means of the front wall 401.

Any air trapped in the male device 1 during the forming can come out by means of the vent elements 404.

FIG. 17 shows a final contact step, in which the supporting device 9 has returned to the first position but the front wall 401 of the inner body 4 continues to press the central portion 301b of the end wall 301 of the shell 3 in the position of contact and continues to cool the shell 3.

However, the front surface 501 of the outer body 5 is again spaced apart from the seal 2 just formed and is again back relative to the front wall 401. In fact, the deformation of the elastic elements 104 is recovered from when the supporting device 9 is lowered and returns to the first position, since the elastic elements 104 return to the extended configuration.

FIG. 18 shows another inactive step, which follows the forming, in which the male device 1 and the supporting device 9 are in the rest configuration and are away from each other.

However, it should be noticed that the extractor 105 has detached the closing element, with the seal 2 just formed in the shell 3, from the male device 1.

As shown in FIG. 20, the outer part 2a of the seal 2 is applied on the outer portion 301a of the end wall 301 of the shell 3 whilst the lateral part 2b of the seal 2 is applied on a portion of the lateral wall 302.

Therefore, it should be noticed that, thanks to the outer circuit 6 it is possible to effectively cool the seal 2 but, at the same time, since the outer circuit 6 is defined between the inner jacket 502 and the outer jacket 503 fixed to each other in a sealed fashion, preferably separatable from each other, it is possible to make the outer circuit 6 in a simple and inexpensive way.

1. A moulding male device (1) for forming a sealing material (2′) inside a shell (3) and for obtaining a seal (2), wherein the male device (1) extends along a longitudinal axis (Z) and comprises:
an inner body (4), which has a front wall (401) configured to press a central portion (301b) of an end wall (301) of the shell (3);
an outer body (5), externally surrounding the inner body (4), having a front surface (501) configured to press the sealing material (2′ ), applied at least on an outer portion (301a) of the end wall (301), and to form the seal (2);
a ducting circuit (6, 8), configured to allow a transit of a cooling fluid inside the male device (1); the moulding male device (1) being characterised in that the ducting circuit (6, 8) comprises an outer circuit (6) at least partly made in the outer body (5); and wherein the outer body (5) comprises an inner jacket (502), surrounding the inner body (4), an outer jacket (503), surrounding the inner jacket (502); the outer circuit (6) being at least partly made between the inner jacket (502) and the outer jacket (503).

2. The male device (1) according to claim 1, wherein the outer circuit (6) comprises an outer infeed stretch (602) and an outer outfeed stretch (601), which are distributed around the longitudinal axis (Z), and at least one outer connecting stretch (603) positioned between the outer infeed stretch (602) and the outer outfeed stretch (601);
wherein the inner jacket (502) comprises at least one inner hollow (504); or the outer jacket (503) comprises at least one outer hollow (505); or the inner jacket (502) comprises at least one inner hollow (504) and the outer jacket (503) comprises at least one outer hollow (505); for delimiting the outer infeed stretch (602), the outer outfeed stretch (601), or the outer connecting stretch (603).

3. The male device (1) according to claim 2, wherein the outer body (5) comprises an upper part defined by an inner upper part (502′) of the inner jacket (502) and by an outer upper part (503′) of the outer jacket (503); a lower part defined by an inner lower part (502″) of the inner jacket (502) and by an outer lower part (503″) of the outer jacket (503); and wherein the outer circuit (6) comprises an upper outer section made in the upper part and a lower outer section made in the lower part, connected to each other, the upper outer section and the lower outer section having shapes which are different from each other.

4. The male device (1) according to claim 3, on claim 2, wherein the upper outer section comprises an upper infeed section of the outer infeed stretch (602) and an upper outfeed section of the outer outfeed stretch (601) each comprising a single outer upper hollow (505′) made in the outer upper part (503′);
and wherein the lower outer section comprises a lower infeed section of the outer infeed stretch (602) and a lower outfeed section of the outer outfeed stretch (601) each comprising a pair of inner lower hollows (504″) made in the inner lower part (502″).

5. The male device (1) according to claim 4, wherein the outer infeed stretch (602) and the outer outfeed stretch (601) are linear and parallel to the longitudinal axis (Z), and wherein in particular the upper outer section and the lower outer section are linear, and parallel to the longitudinal axis (Z).

6. The male device (1) according to claim 2, wherein the outer infeed stretch (602) and the outer outfeed stretch (601) are diametrically opposed and wherein the outer connecting stretch (603) comprises at least one curved portion defined by a respective curved hollow (506).

7. The male device (1) according to claim 1, and comprising an intermediate body (7) which has an annular shoulder (701) which abuts an upper edge (503a) of the outer body (5), positioned axially on the opposite side to the front surface (501), and has an intermediate portion (702) which projects axially from the annular shoulder (701), to which the outer body (5) is fixed in a sealed fashion, the intermediate portion (702) being interposed between the outer body (5) and the inner body (4).

8. The male device (1) according to claim 2, wherein outer circuit (6) comprises an intermediate infeed stretch (604) and an intermediate outfeed stretch (605), which are made in the intermediate body (7) and are connected respectively to the outer infeed stretch (602) and to the outer outfeed stretch (601).

9. The male device (1) according to claim 1, wherein the inner body (4) comprises a forming element (402) having the front wall (401), and a cup-shaped element (403); wherein the cup-shaped element (403) surrounds in a sealed fashion the forming element (402).

10. The male device (1) according to claim 9, wherein the cup-shaped element (403) comprises a lateral outer surface (403a) which comprises a plurality of vent elements (404) distributed around the longitudinal axis (Z) to allow the venting of any air trapped in the male device (1) during forming of the sealing material (2′ ).

11. The male device (1) according to claim 10, wherein the lateral outer surface (403a) comprises an upper portion (403a′) and a lower portion (403a′), and wherein the vent elements (404) comprise upper vent grooves (404′) and lower vent grooves (404″) respectively positioned in the upper portion (403a′) and in the lower portion (403a′), the upper vent grooves (404′) being shaped and distributed differently from the lower vent grooves (404″), for example the upper vent grooves (404′) having a greater angular extent than the lower vent grooves (404″) and/or being angularly positioned in different positions.

12. The male device (1) according to claim 10, or 11, wherein the vent elements (404) are positioned parallel to the longitudinal axis (Z) and are circumferentially regularly spaced.

13. The male device (1) according to claim 9, wherein the ducting circuit (6, 8) comprises an inner circuit (8) at least partly made between the forming element (402) and the cup-shaped element (403).

14. The male device (1) according to one of claim 9, and comprising an inner core (405), with tubular shape, to which the forming element (402) is coupled, and a ring (406) which is interposed between the cup-shaped element (403) and the forming element (402), surrounds the forming element (402) and is placed in contact with the front wall (401).

15. The male device (1) according to claim 14, wherein the inner circuit (8) is at least partly made in the inner core (405) and around the ring (406); the inner circuit (8) comprising an inner infeed stretch (801) and an inner outfeed stretch (802) which are inside the inner core (405), and lead into the forming element (402); and an inner connecting stretch (805) for connecting to each other the inner infeed stretch (801) and the inner outfeed stretch (802), which extends around the ring (406).

16. The male device (1) according to claim 1, wherein the inner jacket (502) and the outer jacket (503) are made as distinct and separatable components, fixed to each other in a sealed fashion, so that they can easily be made and allow simple assembly or disassembly of the outer body (5).
